(19) United States
(12) Patent Application Publication
(10) Pub. No.: US 2009/0060160 A1
(43) Pub. Date: Mar. 5, 2009

(54) Switch having notification system

(75) Inventor: George Kassas, Salem, NH (US)

Correspondence Address: ROPES & GRAY LLP, PATENT DOCKETING 39/41, ONE INTERNATIONAL PLACE, BOSTON, MA, 02110-2624, US

(73) Assignee: Cedar Point Communications, Inc., Derry, NH (US)

(21) Appl. No.: 12/220,844

(22) Filed: Jul. 28, 2008

Related U.S. Application Data
(60) Provisional application No. 60/962,290, filed on Jul. 27, 2007.

(51) Int. Cl. H04M 3/42; H04M 7/00

(52) U.S. Cl. 379/207.02; 379/221.14

(57) ABSTRACT

Telecommunications switches for connecting circuits across a network and having an emergency notification system that allows access to customer premise equipment, such as a telephone, mobile telephone, VOIP telephone, or any other type of customer premise equipment, and delivers to that CPE an alarm or another message. The telecommunication switch may include a dial plan server that will allow a security officer or other user to develop a dialing plan that controls telecommunication switch such that identification numbers, typically telephone numbers, can be dialed by the switch to call CPE throughout the telecommunication network. Additionally, the dialing plan allows the security officer to divide and organize an institution into different sectors, and these different sectors may be delivered different messages. The sectors may be geographic, they may be organized based on the classification of individuals within the institution, or they may be based on some other characteristic.

### REFERENCE TO RELATED APPLICATIONS

This application claims priority to Provisional Application Ser. No. 60/962,290, filed on Jul. 27, 2007, and incorporated herein by reference in its entirety.

### FIELD OF THE INVENTION

This invention relates to data communications and in particular to communications switches and features thereof.

### BACKGROUND

Today, security is a serious issue for the general population. To address the current heightened concern over security, law enforcement officials, government agencies and engineers have worked together to develop several emergency notification systems and alarm systems that deliver warnings and security related information to a large portion of the population and over large geographic areas.

For example, one well known system is the Emergency Broadcast System (EBS) that allows a government agency to employ the broadcast networks communicating with consumer television and radio sets to deliver a message to the public across these major broadcast mediums. The EBS was put in place around 1963 as part of a plan to support the government's civil defense efforts and to provide the nation with an emergency warning system. The EBS can be activated regionally or nationally and offers an effective way to deliver general information to the public.

Although the EBS can work quite well, it requires the government to take command of local broadcast networks, both radio and television, and thus is not a system that is readily available to local governments or private individuals for giving an emergency warning.

Recently, security officers at large enterprises such as universities, hospitals, and large corporations have been charged with increasing the security of the installation for which they are responsible. As many of these institutions are quite large and geographically distributed, it is difficult for these security officers to provide warning messages and information using conventional tools and systems. To address this deficiency, security companies have developed notification systems that are essentially a network of alarm systems. These alarm systems can be distributed throughout an institution such as a campus or a hospital and network back to a main security system that will allow a security officer to activate and deactivate selected ones of these alarms. In this way, the security officer can provide notification and messages to the individuals located across the institution, as well as to any emergency responders that are addressing the security issue at the institution. Further, these system can provide an intelligent network system that allows the security officer to deliver different messages to different alarm devices, thereby allowing for one part of the population to receive a message that is different from another part of the population.

Although these security systems can work quite well, they may be costly to install and they require that the security officers constantly adjust the location and distribution of the distributed alarms such that the alarms are kept proximate to the population, even as the population relocates over time from one location at the facility to another. As the facility is expanded or as areas of the facility are retasked, the security officers must make sure that the appropriate number of alarms are placed close enough to the population that the population be confident that they will receive the alarms and messages when they are generated. This can be a time consuming and labor intensive process.

Accordingly, there is a need in the art for systems and methods that provide emergency notification and alarms to the working or residential population of a general institution. Further, there is a need in the art for systems that provide the effective coverage of the EBS with the ability to tailor and control the messages being delivered to different sections of the population.

### SUMMARY OF THE INVENTION

The systems and methods described herein provide telecommunications switches that enable notification systems.

In particular, the systems and methods described herein include, among other things, telecommunication switches for connecting circuits across a network to allow for communications between two entities on the network. The telecommunication switches may include an emergency notification system that allows for a security officer or other user to access equipment coupled to a communications network. Such equipment is typically, but not always, customer premises equipment or customer provided equipment (CPE), such as a telephone, mobile telephone, VOIP telephone, cable modem, set top box, DSL modem or any other type of equipment that may connect with a carrier's telecommunication channel or the to a separate channel operated by a facility or other institution. The systems through its hierarchical intelligent dialing plan enable the CPE to receive an alarm or another message generated by the security officer or other user.

The telecommunication switch may include a dial plan function that will support development of a dialing plan that controls the telecommunication switch such that identification numbers, typically telephone numbers, can be dialed by the switch to call CPE throughout the telecommunication network. Additionally, the dialing plan allows a security officer or other user to divide and organize an institution into different sectors, and these different sectors may be delivered different messages. The sectors may be geographic, they may be organized based on the classification of individuals within the institution, or they may be based on some other characteristic. In any case, the telecommunication switch allows the security officer to divide the institution into different sectors and enable the delivery of a message to a particular sector or deliver different messages to different sectors.

The dialing plan will be acted on by the telecommunication switch to deliver out to the CPE associated with the different sectors, the messages selected and for the respective sectors. In this way, a security officer can employee the telecommunication network installed at a local institution to provide improved security through early warnings and messages that have been tailored to different sectors and regions of the institution.

In particular, the systems herein provide telecommunication servers for switching calls between equipment on a communication network. The telecommunications server may comprise a switch for connecting two or more circuits together as a function of an identifying number representative of certain equipment on the communications network. A dial plan server may be present in a telecommunications server and may have an overlay processor for maintaining a list of equipment on the communications network and associated the equipment into one or more pre-defined sectors. The dial plan server may also have a message server for associating a message with a trigger condition and responsive to the trigger condition, operating the switch to automatically deliver a message to one or more of the pre-defined sectors by employing the associated identifying numbers of the equipment classified into the pre-defined sectors.

The telecommunications server may include a message server that provides the identifying numbers to the switch in sequential order or in parallel order or in any order suited to the application. The telecommunications server may have a memory that stores at least two messages wherein a first message is associated with a first sector and a second message is associated with a second sector.

In alternate embodiments the telecommunications server may comprise of a second switch and the message server provides the identifying numbers to the first and second switches in parallel. In a further optional embodiment the telecommunications server may have a user interface for allowing a user to generate the message to send to a sector and for implementing a dialing plan or a dial plan for calling to sectors selected by the user. The switch may support TDM, or VOIP service or any other kind of service suitable for a voice communication between one or more entities on a network.

The telecommunication server can also have a message server that includes an alarm processor for generating an alarm message for activating a visual display and an audio display for indicating an alarm condition.

The telecommunication server may also include means for classifying individuals into the pre-defined sectors as a function of equipment identifying numbers associated with the individuals.

In a further embodiment the invention provides a notification system for use on a campus having multiple sectors or being capable of being divided into multiple sectors. The system may comprise a telephone system that has an exchange and a plurality of telephone lines distributed across the campus, multiple sets of telephone equipment connected to the distributed telephone lines and each having at least one associated telephone number and a message server that is coupled to the exchange. The message server can have an overlay process for mapping sectors of the campus to at least one telephone number associated with a telephone equipment set located within the respective campus sector, and the system can also include a user interface for allowing a user to generate a message to send to a campus sector and for implementing a dial plan for calling to telephone devices or equipment within the campus sector that has been selected by the user.

Optionally in this embodiment the telephone equipment can include a visual or audio alarm or some other kind of warning alarm to alert users or people in a sector in an event taking place and to optionally to provide instructions or directions. To this end, the message server can have a memory for storing at least two messages wherein a first message is associated with a first sector and a second message is associated with a second sector. The first sector may be associated with equipment on the campus and a second sector may be associated with equipment that is off the campus. The dialing plan allows for communicating with a pre-selected category of campus staff individuals as well as locations on that campus. The user interface may include a message builder or generator for creating a message capable of being delivered over a phone system and for activating at least one on the telephone equipment sets.

### BRIEF DESCRIPTION OF THE DRAWINGS

The present disclosure may be better understood and its numerous features and advantages made apparent to those skilled in the art by referencing the accompanying drawings.

FIG. 1 depicts one embodiment of an emergency notification system employing a telecommunications switch as described herein;

FIG. 2 depicts pictorially the generation of a dialing plan for use with the system depicted in FIG. 1;

FIG. 3 depicts pictorially the generation of a sector map;

FIG. 4 depicts one process according to the invention for using the system depicted in FIG. 1 to generate a contingency dialing plan;

FIG. 5 depicts the use of the system depicted in FIG. 1 for delivering an alarm or other warning to sectors of an institution.

FIGS. 6a and 6b depict one example of a digit translation table.

The use of the same reference symbols in different drawings indicates similar or identical items.

### DETAILED DESCRIPTION

The systems and methods described herein provide, among other things, systems that allow security officers and other users to develop and implement dialing plans for sectors that exist or can be defined within an institution. The systems will use one or more telecommunication switches to carry out a dialing plan and to make calls, optionally with a security message developed by the security officer. The systems may be integrated into a telecommunication switch thus providing an installed switch with an emergency notification system. As will be described in more detail below, the switches may organize an institution or group of institutions into sectors and develop a dialing plan including routing information for different calls, digit translations and other steps all being prepared ahead of time to facilitate the rapid (for example up to about 100 simultaneous calls per second) dialing of numbers associated with a selected sector.

The systems and methods described herein may be used at a campus, a business, a city, a hospital, a city or any kind of institution, enterprise or other entity, that has need for a security system and that provides telecommunication equipment within that area. For the purpose of clarity the systems and methods described herein will be described with reference to a system deployed on a campus or a university. However, this embodiment is merely for the purpose of illustration and it will be understood that the systems and methods described are not so limited and that in other embodiments and practices may be realized without departing from the scope hereof.

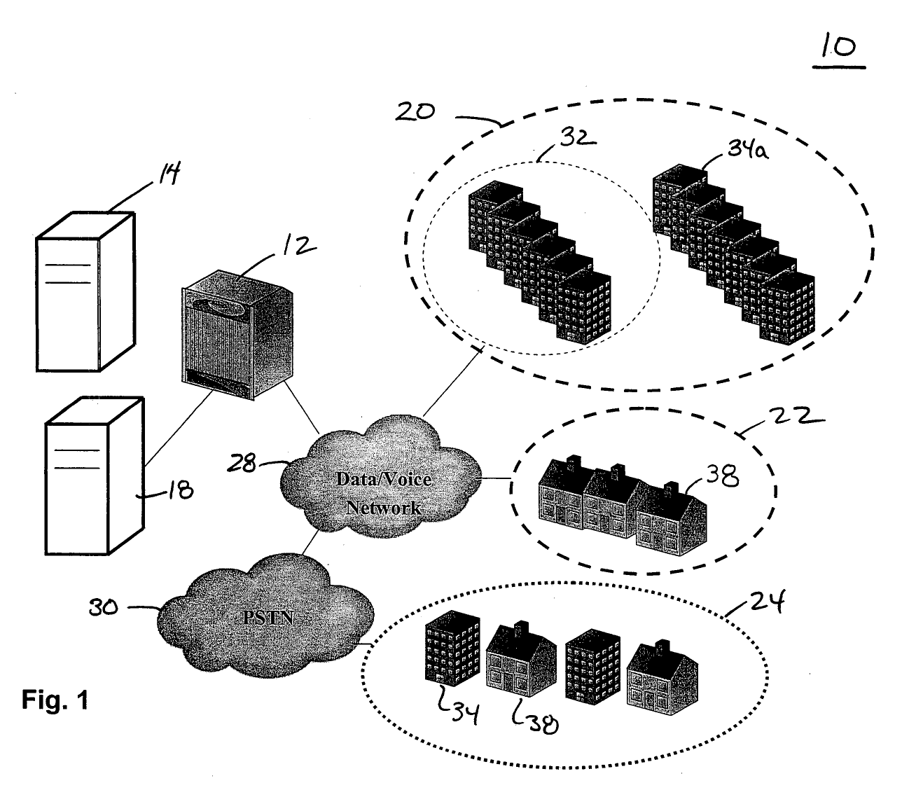

FIG. 1 depicts a first embodiment, and shows a system 10 that includes a telecommunication switch having an emergency notification system. In particular, FIG. 1 shows a system 10 having an overlay processor 14, a dial plan server 18, a telecommunication switch 12, three regions within an institution 20, 22 and 24 respectively, a data/Voice network 28, a telephone network 30, a sub-sector 32, multi floor buildings 34A-34G, and residential homes 38.

The dialing plan server 18 depicted in FIG. 1 creates and/or stores one or more dialing plans that may be executed by action of the telecommunication switch 12. In one embodiment, the dialing plan server 18 employs information generated by the overlay processor 14 to create a set of files, such as XML files that may be employed by the switch 12 to dial to the customer premise equipment (CPE) within the identified sectors. In the depicted embodiment the dialing plan server 18 is shown as a separate data processing platform of the type commonly employed for implementing server software. The data processing platform may be a UNIX platform executing a computer software program that allows an security officer to generate alert messages ready for transmission when triggered by the dial plan. However, it will be understood by those of skill in the art that in alternate embodiments the dialing plan server 18 may be integrated within the telecommunication switch 12. In such an embodiment, the telecommunication switch 12 may export or provide a user interface that may be accessed by a person, such as a security officer, to develop a dialing plan that may be implemented by the telecommunication switch 12. Other embodiments and configurations may also be practiced without departing from the scope of the invention.

The overlay processor 14 depicted in FIG. 1 is shown as a separate data processing platform that is capable of generating and creating sectors based on classes. It is noted that the overlay processor 14, like the dialing plan server 18, may be integrated into the telecommunications switch 12 in certain embodiments. Optionally, the overlay processor 14 may be integrated into the dialing plan server 18 and this integrated dialing plan server/overlay processor may be operated on a data processing platform that is separate from the telecommunications switch 12. In either case though, the system will include an overlay processor that typically will be a piece of software executing on a data processing platform and that will identify a set of sectors within an institute or region. The overlay processor 14 organizes identification numbers, typically telephone numbers or NBA/NXX numbers, into categories such as the phone numbers associated with the buildings 34A-34G in the sector 20 depicted in FIG. 1. Alternatively, the overlay processor 14 may organize into a category or a sector a category of personal, such as students or professors, that are associated with the institution, which in this case is a campus.

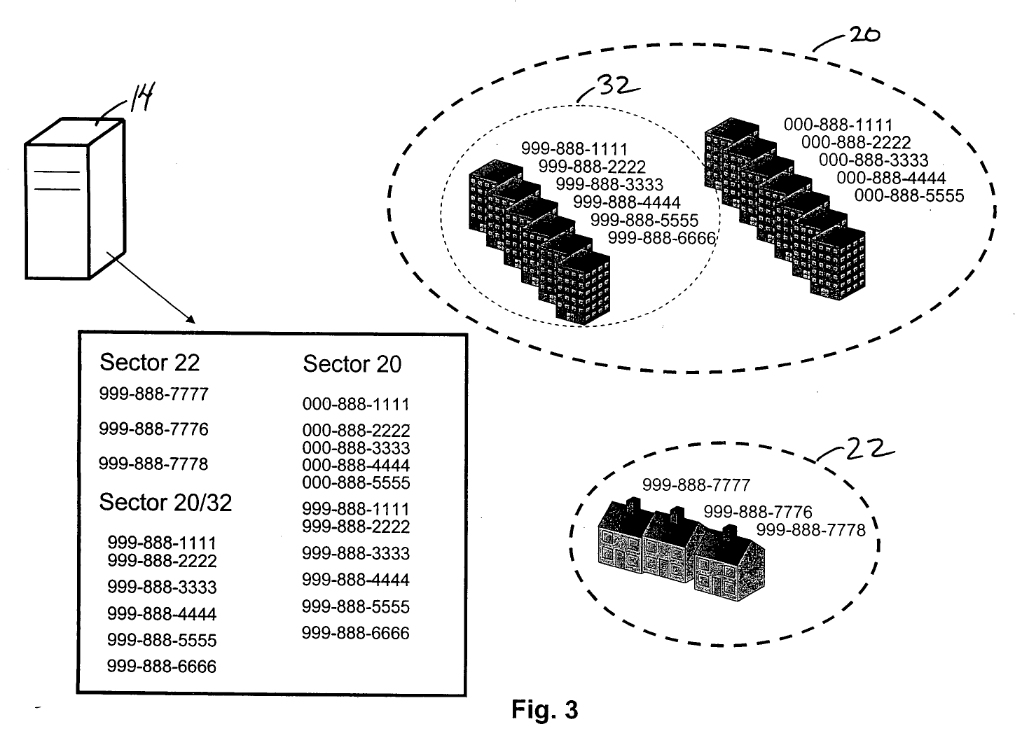

One example of the operation of the overlay processor 14 is presented in FIG. 3. The depicted overlay processor 14 in FIG. 3 allows a user to classify the institution into different sectors. In this example, the overlay processor 14 is organizing the buildings on campus into different sectors. For example, FIG. 3 illustrates that the overly processor 14 has created divided at least some of the buildings on campus into three sectors, one of which exists as a sub-sector within another sector. In particular, the overlay processor 14 is shown as having divided the campus into a first sector, sector 20, that includes the multi-resident housing complexes on campus. A second sector, sector 22, is defined that includes the residential homes on campus. A third sector, sector 32, exists as a sub-sector within sector 20 and may, for example, represent women's only multi-residential housing existing on the campus. As further shown in FIG. 3, the overlay processor 14 identifies the telephone numbers associated with the CPE located within the service areas that fall within the defined sectors. The telephone numbers are assigned to geographical locations and coupled with physical ports in distinct structures (buildings, floors, etc.). Each telephone is assigned a physical address and in the case of an IP phone, an IP address is also assigned. Thus, the overlay processor 14 generates a set of telephone numbers that are associated with CPE within respective sectors. In the embodiment and practice depicted in FIG. 3, the campus has been divided into sectors based on the type of residences across the campus. In alternative practices, the campus may be divided based on the function of different rooms, such as sectors that contain dormitories and sectors that contain cafeterias. Further, the system may be employed to create sectors that contain the telephone numbers for all faculty or freshman woman. Further, some sectors may be created for night time use, and other sectors for day time use. Still other methods by which the campus, or other institution may be sectorized may be practiced and will vary according to the application and security issues being addressed. As will be described in more detail hereinafter, the notification system may provide one message to the equipment in the sector 20 and a second additional and/or different message to the equipment within the sub-sector 32.

The CPE in the sectors may be contacted through the switch 12. The depicted telecom switch 12 may be any suitable communication switch of the type capable of establishing a connection between two or more devices on a communications network. In the embodiment depicted in FIG. 1, the system 10 includes a single telecommunication switch 12. However, in alternate embodiments there may be a plurality of telecommunication switches 12, each of which is capable of dialing phone numbers within a sector and thus providing parallel dialing operations for the notification system depicted in FIG. 1.

As further shown in FIG. 1, the telecommunication switch may couple to a data network 28. Typically the data network 28 will be the internet data network that interconnects the telecommunication switch 12 with other devices coupled to the internet. Also shown in FIG. 1, is a telephone network, in this case, the PSTN telephone network 30. In the embodiment depicted in FIG. 1 the telephone network 30 couples through the data network 28 to the switch 12. However in alternate embodiments, the telecommunication switch 12 may couple directly to the telephone network 30. In either way, it is understood from FIG. 1 that the telecommunication switch 12 can couple through the data network 28 to certain equipment coupled to the communications network and may use the telephone network 30 to couple to and communicate with equipment on the telephone network.

FIG. 1 further depicts that the data network 28 may couple to a second sector 22. In this case the separate sector 22 may include a plurality of homes 38 which represent off-campus housing associated with the university. Additionally, the phone network 30 may be employed to communicate with a separate sector 24 depicted in FIG. 1 as comprising residential and multi-residential buildings. The sector 24 may represent off-campus buildings and residences associated with home addresses of students presently resident in sub-sector 32. Thus, as described in more detail hereinafter, the notification system 10 may be employed for delivering messages to on campus CPE and to off campus CPE as well.

The emergency notification system that includes the telecommunications switch 12, the overlay processor 14 and the dial plan server 18 is capable of communicating across both the data network 28 and to areas served by the telephone network 30. Thus, in the embodiment in FIG. 1, the dial plan server 18 and overlay processor 14 may be employed for generating a dialing plan that provides warnings and notification to equipment stored in sectors that are part of the facility, such as sectors 20 and 22, as well as to sectors that exist outside of the facility, such as the depicted sector 24. Thus, a user can employ the system 10 to generate a dialing plan that provides notice to any communication equipment coupled to either the data network or the telephone network, 28 and 30 respectively.

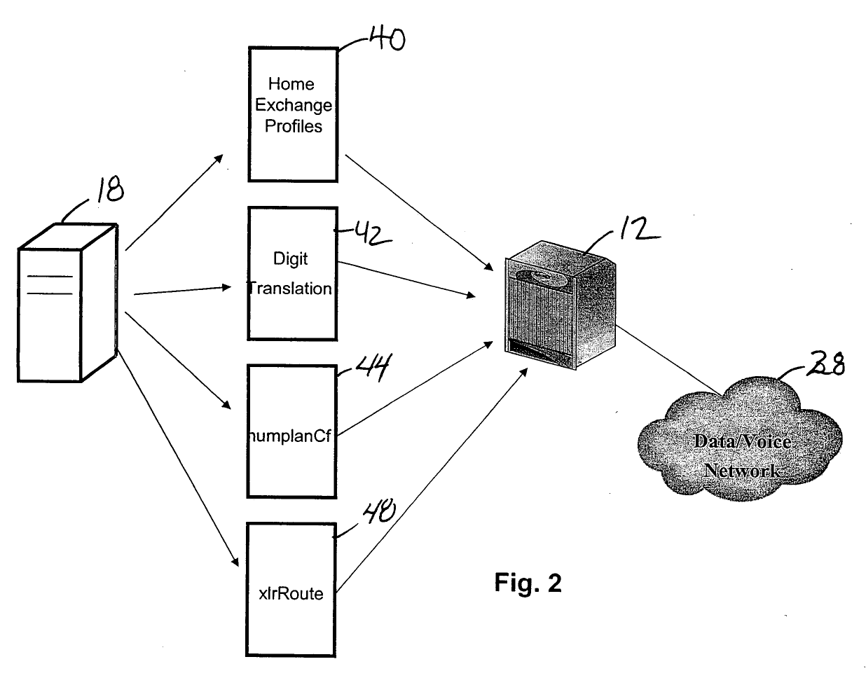

FIG. 2 depicts pictorially the generation of a dialing plan by the dialing plan server 18. In particular, FIG. 2 depicts the switch 12, the dialing plan server 18, and the data network 28. Further shown in FIG. 2 is that the dialing plan server 18 generates, in this embodiment, four data files that organize the information that is used by switch 12 to carry out the dialing plan. In the depicted embodiment the dial plan server 18 generates a home exchange profile data file 40, a digit translation profile 42, a number plan configuration file 44 and a translation route data file 48. In one embodiment, the data files 40, 42, 44 and 48 are XML data files of the type employed for exchanging information between servers. In this embodiment, the telecommunications switch 12 may be any server capable of processing XML data files to dial phone numbers to connect communication devices over a network. In one particular embodiment, the telecommunications switch 12 is the SAFARI telecommunications switch manufactured and sold by the assignee hereof. However, it will be apparent to those of skill in the art that any suitable telecommunication switch may be employed as long as that telecommunication switch is capable of responding to stored instructions representative of a plan for dialing to equipment located in the service area of the switch or for connecting to another switch within the service area to reach equipment outside of the respective switches service area.

The home exchange profile data file 40 defines the serving area of the telecommunications switch 12, or in embodiments where multiple telecommunications switches are being employed, the home exchange profile data file 40 may define the service areas supported by all the telecommunication switches. Table 1 presents an example of the home exchange profile data file.

TABLE 1

| id | homeID_fname | XLR_tableID | RC_fname | LATA_fname | locale |
|---|---|---|---|---|---|
| 1 | ASHLAND_HANO | 1 | ASHLAND | 248 | HANO |
| 2 | BETHIA_CHES | 1 | BETHIA | 248 | CHES |
| 3 | CHESTER_CHES | 1 | CHESTER | 248 | CHES |
| 4 | SUSPEND_CHES | 5 | | 248 | CHES |

The digit translation file 42 contains the information needed to translate between different phone numbers. The digit translation file 42 contains that information that may be used by telecommunications switch 12 to substitute one telephone for another telephone number in those circumstances where the phone numbers have been changed or redirected. One example of a digit translation file is set out in exhibit A appended hereto.

The number plan configuration file 44 defines the local NPA/NXX bindings to the rate centers and therefore provides the switch with the local exchange bindings required to carry out the dialing plan proposed by the dialing plan server 18.

TABLE 2

| id | filename | pattern | tableTYPE |
|---|---|---|---|
| 1 | 248 | 434 | LATA |
| 2 | 248 | 804 | LATA |
| 3 | ASHLAND | 804365 | RC |
| 4 | ASHLAND | 804368 | RC |
| 5 | ASHLAND | 804412 | RC |
| 6 | ASHLAND | 804459 | RC |
| 7 | ASHLAND | 804496 | RC |
| 353 | ASHLAND | 804507 | RC |
| 354 | ASHLAND | 804795 | RC |
| 355 | ASHLAND | 804899 | RC |
| 356 | BETHIA | 804494 | RC |
| 357 | BETHIA | 804561 | RC |
| 750 | BETHIA | 804506 | RC |
| 751 | BETHIA | 804507 | RC |
| 752 | BETHIA | 804795 | RC |
| 753 | BETHIA | 804899 | RC |
| 754 | CHESTER | 804365 | RC |
| 758 | CHESTER | 804496 | RC |
| 1154 | CHESTER | 804795 | RC |
| 1155 | CHESTER | 804899 | RC |

The translation route data file 48 is an XML data file that contains information for the switch 12 which will define the call routing based on carrier, called, or locale routing processes. Thus, the routing data file 48 contains information for the switch 12 for routing data through the data network and through the telephone network to different sectors defined by the user.

TABLE 3

| id | tableName | routePattern | group_num1 | exactlen | group_num2 | group_num5 |
|---|---|---|---|---|---|---|
| 1 | LOCALE | CHES | 8 | 3 | 9 | |
| 2 | LOCALE | COLO | 10 | 3 | 11 | |
| 3 | LOCALE | DINW | 12 | 3 | 13 | |
| 4 | LOCALE | GOOC | 10 | 3 | 11 | |
| 5 | LOCALE | HENR | 14 | 3 | 15 | |
| 6 | LOCALE | HANO | 12 | 3 | 13 | |
| 7 | LOCALE | LOUI | 9113 | 3 | 9114 | |
| 8 | LOCALE | PETE | 9115 | 3 | 9116 | |
| 9 | LOCALE | POWH | 9999 | 3 | 9999 | |
| 10 | LOCALE | RICH | 18 | 3 | 19 | |
| 11 | CARRIER | 0386 | 7 | | | |
| 12 | CALLED | 0 | 20 | 1 | | |
| 20 | CALLED | 08 | 20 | | | |
| 21 | CALLED | 09 | 20 | | | |
| 22 | CALLED | 011 | 7 | | | |
| 23 | CALLED | 800 | 6 | 10 | 4 | |
| 27 | CALLED | 888 | 4 | 10 | 5 | |
| 28 | CALLED | 8002017882 | 7 | 10 | | |
| 32 | CALLED | 8046810993 | 55 | 10 | | |
| 33 | CALLED | 8049189960 | 55 | 10 | | |
| 34 | CALLED | 434210 | 1 | 10 | 7 | |
| 266 | CALLED | 804427 | 2 | 10 | 7 | |
| 581 | CALLED | 804997 | 2 | 10 | 7 | |
| 582 | CALLED | 804998 | 2 | 10 | 7 | |

FIG. 2 thus shows that the dialing plan server 18 is capable of pre-configuring the data necessary to implement a dialing plan and stores the information as a set of pre-configured files that can be rapidly executed by the telecommunications switch 12 as the information necessary for completing the calls is pre-computed, pre-defined and readily available to the telecommunications switch 12. FIG. 2 depicts one set of data files representative of the data files for one dialing plan. However, in normal use, the dialing plan server 18 will be used for developing multiple and hierarchical dialing plans and these multiple dialing plans can be stored in a data base (not shown) for later use as needed.

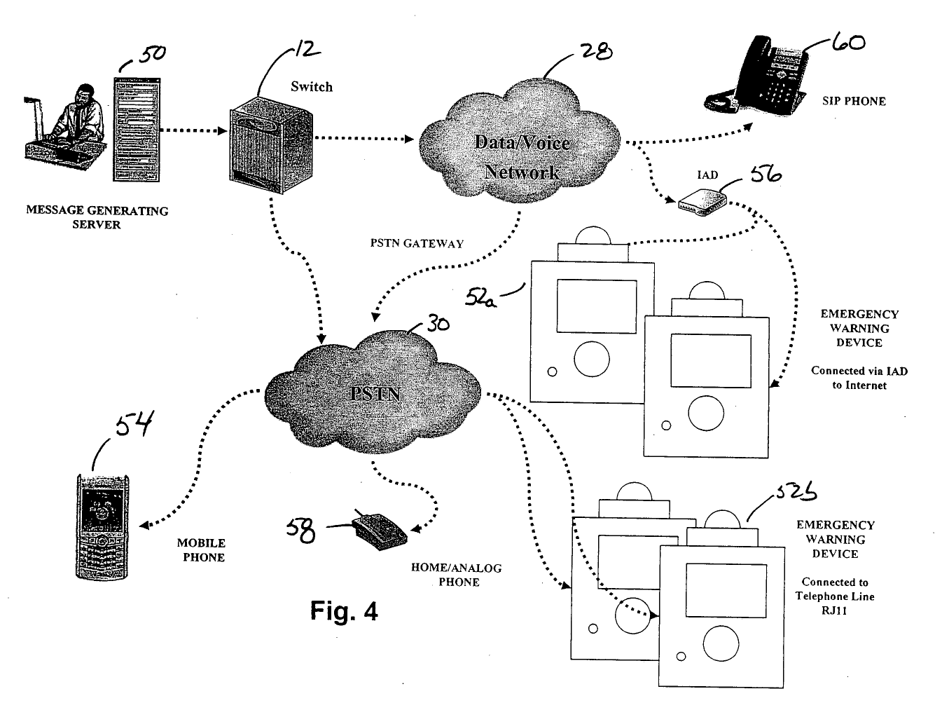

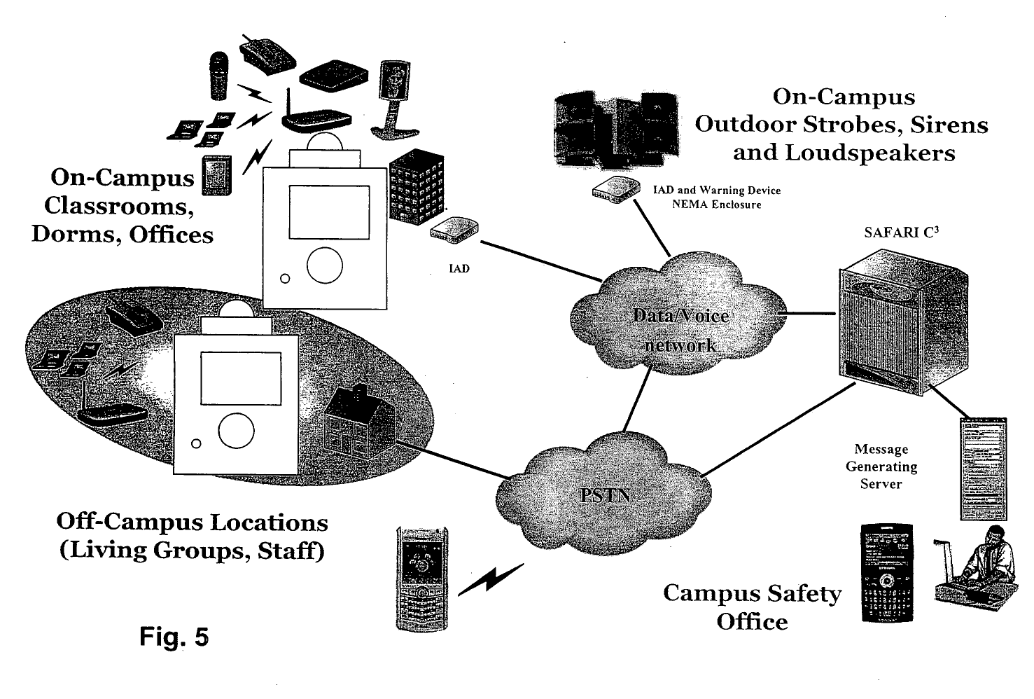

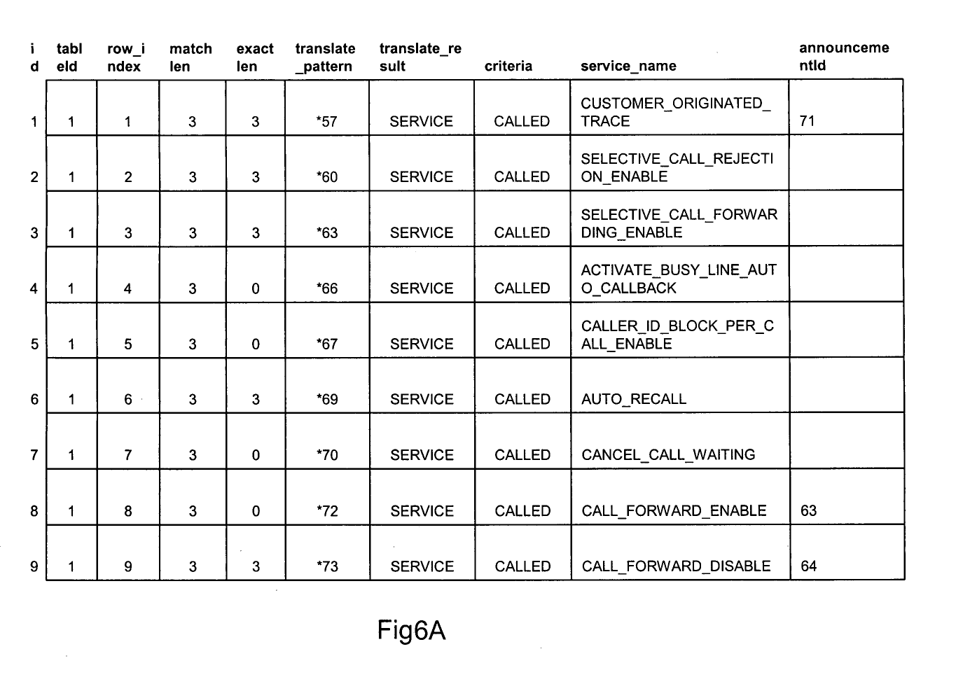

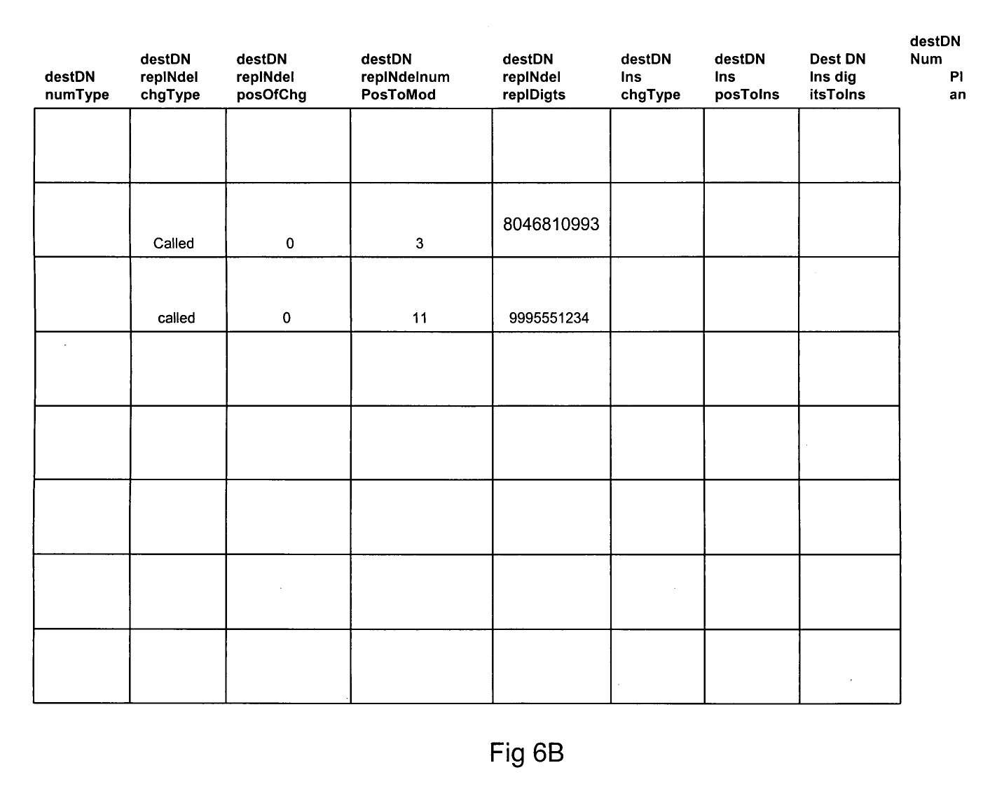

Turning to FIG. 4, the system 10 depicted in FIG. 1 is illustrated with a user operating a message generating server 50. The messenger application server 50 provides a user interface that a security officer or other system administrator may use to develop messages that may be delivered according to a dialing plan such as the dialing plans depicted and described with reference to FIG. 2. In operation, the messenger application server 50 allows the security officer to enter a message to be delivered as part of the dialing plan. This message may be transmitted to the telecommunications switch 12 along with the dialing plan and the switch 12 can institute the dialing plan and deliver the message as each call is made. As shown in FIG. 4, the switch 12 can communicate across the data network 28 to SIP-enabled phones such as the phone 60 and to proprietary alarm devices such as the devices 52A and 52B. The device 52A communicates through the INTEGRATED ACCESS DEVICE (IAD) 56. This is a device that is used to accommodate all kinds of access elements communicating with the switch and receives and sends data through the data network 28 from the switch 12. The proprietary alarm device 52B couples to the telephone network 30 and receives data from the switch 12 delivered through the data network 28 and through a gateway to the telephone network 30. FIG. 4 further shows that the telephone gateway may be employed for delivering messages to the mobile phone 54 and to the home analog phone 58. Thus, FIG. 4 shows that the messenger application server allows a security officer to select a dialing plan and to develop a message for delivery with that dialing plan.

The order in which the steps of the present method are performed is purely illustrative in nature. In fact, the steps can be performed in any order or in parallel, unless otherwise indicated by the present disclosure.

The methods may be performed in hardware, software, or any combination thereof, as those terms are currently known in the art. In particular, the present method may be carried out by software, firmware, or microcode operating on a computer or computers of any type. Additionally, software embodying the present invention may comprise computer instructions in any form (e.g., source code, object code, microcode, interpreted code, etc.) stored in any computer-readable medium (e.g., ROM, RAM, flash memory, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the present invention is not limited to any particular platform, unless specifically stated otherwise in the present disclosure.

While particular embodiments have been shown and described, it will be apparent to those skilled in the art that changes and modifications may be made without departing from this invention in its broader aspect and, therefore, the appended claims are to encompass within their scope all such changes and modifications as fall within the true spirit of this invention.

We claim:

1. A telecommunications server for switching calls between equipment on a communications network, comprising
a switch for connecting two or more circuits together as a function of an identifying number representative of certain equipment on the communications network,
a dial plan server having
an overlay processor for maintaining a list of equipment on the communications network and associating the equipment into one or more predefined sectors,
a message server for associating a message with a trigger condition and responsive to the trigger condition, operating the switch to automatically deliver a message to one more of the predefined sectors by employing the associated identifying numbers for the equipment classified into the predefined sectors.

2. The telecommunications server according to claim 1, wherein the message server provides the identifying numbers to the switch in sequential order.

3. The telecommunications server according to claim 1, having a memory for storing at least two messages, wherein a first message is associated with a first sector and a second message is associated with a second sector.

4. The telecommunications server according to claim 1, further comprising a second switch and wherein the message server provides the identifying numbers to the first and second switches in parallel.

5. The telecommunications server according to claim 1, further comprising
a user interface for allowing a user to generate the message to send to a sector and for implementing a dialing plan for calling to sectors selected by the user.

6. The telecommunications server according to claim 1, wherein the switch supports at least one of TDM or VOIP service.

7. The telecommunications server according to claim 1, wherein the message server includes an alarm processor for generating an alarm message for activating a visual display and an audio display for indicating an alarm condition.

8. The telecommunications server according to claim 1, further comprising
means for classifying individuals into the predefined sectors as a function of equipment identifying numbers associated with the individuals.

9. A notification system for use on a campus having multiple sectors, comprising
a telephone system having an exchange and a plurality of telephone lines distributed across the campus,
multiple sets of telephone equipment connected to the distributed telephone lines and each having at least one associated telephone number,
a message server coupled to the exchange and having an overlay process for mapping sectors of the campus to at least one telephone number associated with a telephone equipment set located within the respective campus sector, and
a user interface for allowing a user to generate a message to send to a campus sector and for implementing a dialing plan for calling to telephone devices within the campus sector selected by the user.

10. The system according to claim 9, wherein at least some of the telephone equipment includes a visual or audio alarm.

11. The system according to claim 9, wherein the message server has a memory for storing at least two messages, wherein a first message is associated with a first sector and a second message is associated with a second sector.

12. The system according to claim 11, wherein the first sector is associated with equipment on the campus and the second sector is associated with equipment off the campus.

13. The system according to claim 9, including a dialing plan for communicating with a pre-selected category of campus staff individuals.

14. The system according to claim 9, including a dialing plan for communicating with a pre-selected category of campus locations.

15. The system according to claim 9, wherein the user interface includes a message builder for creating a message capable of being delivered over a phone system and for activating at least one of the telephone equipment sets.
